(19) United States
(12) Patent Application Publication
(10) Pub. No.: US 2025/0191095 A1
(43) Pub. Date: Jun. 12, 2025

(54) Innovative Recombination Recommendation System for Corporate Knowledge Base and Method Thereof

(71) Applicants: SQ Technology (Shanghai) Corporation, Shanghai (CN); Inventec Corporation, Taipei City (TW)

(72) Inventors: Ming Lu, Shanghai (CN); Qiu-Long Jing, Shanghai (CN); Yan-Xiang Chen, Shanghai (CN); Po-Shuo Chiu, Taipei City (TW)

(21) Appl. No.: 18/601,601

(22) Filed: Mar. 11, 2024

(30) Foreign Application Priority Data
Dec. 6, 2023 (CN) 202311669761.1

(51) Int. Cl. G06Q 50/18

(52) U.S. Cl. CPC G06Q 50/184

(57) ABSTRACT

An innovative recombination recommendation system for a corporate knowledge base and a method thereof are disclosed. In one aspect, an innovation summary is split into phrases. Each of the phrases is vectorized to generate a phrase vector. The phrase vectors are transmitted to a corporate knowledge base and compared with mathematical vectors of pieces of patent raw data to calculate a first vector distance, and the patent raw data with the first vector distance exceeding a threshold value is selected. The phrases may be recombined, and the recombined phrases are vectorized to generate a combination vector. This combination vector is compared with the mathematical vector of the selected patent raw data to calculate a second vector distance. When the second vector distance does not exceed the threshold value, an evaluation pass message is generated based on the recombined phrase.

### CROSS-REFERENCE TO RELATED APPLICATION

This application claims the benefit of Chinese Application Serial No. 202311669761.1, filed Dec. 6, 2023, which is hereby incorporated herein by reference in its entirety.

### BACKGROUND OF THE INVENTION

### 1. Field of the Invention

The present invention is related to an innovation recommendation system and a method thereof, and more particularly to an innovative recombination recommendation system for corporate knowledge base, and a method thereof.

### 2. Description of the Related Art

In recent years, with the widespread and vigorous development of innovative thinking training, various methods of innovative thinking training have emerged. However, how to effectively assist users in efficiently generating innovations has been a pressing issue for many companies.

Generally, conventional innovative thinking training typically involves several steps including, for example, defining problems, analyzing problems, seeking inspiration, divergent thinking, using creative tools (such as mind map), and iterative improvement, and so on. However, performing a series of steps often requires a significant amount of time, and it causes the issue of inefficient innovation ideation efficiency.

For this reason, some companies have proposed to establish a knowledge base, and leverage the content of the knowledge base in relevant technical domains to assist users in innovative thinking, avoiding situations of excessive divergence. However, when the knowledge base contains a large amount of data, users still need to invest considerable effort in reading, ideating, verifying ideas, etc., leading to the same problem of inefficient innovation ideation.

According to above-mentioned contents, what is needed is to develop an improved solution to solve the problem of inefficient innovation ideation.

### SUMMARY OF THE INVENTION

An objective of the present invention is to disclose an innovative recombination recommendation system for corporate knowledge base and a method thereof, to solve the conventional problem of inefficient innovation ideation.

In order to achieve the objective, the present invention discloses an innovative recombination recommendation system for corporate knowledge base, the innovative recombination recommendation system includes a corporate knowledge base and a server-end device. The corporate knowledge base is configured to store pieces of patent raw data, wherein each of the pieces of patent raw data corresponds to at least one mathematical vector. The server-end device is linked to the corporate knowledge base through network, wherein the server-end device includes a non-transitory computer-readable storage medium and a hardware processor. The non-transitory computer-readable storage medium is configured to store computer readable instructions. The hardware processor is electrically connected to the non-transitory computer-readable storage medium, and configured to execute computer readable instructions to make the server-end device execute: receiving an innovation summary, splitting the innovation summary into phrases, and vectorizing each of the phrases to generate a phrase vector; transmitting the phrase vectors to the corporate knowledge base, and comparing the phrase vectors with the mathematical vectors, one by one, and calculating a first vector distance between the phrase vectors and each of the mathematical vectors; when one of the first vector distances exceeds a threshold value, selecting the piece of the patent raw data corresponding to the one of the first vector distances; recombining the phrases, vectorizing the recombined phrases to generate a combination vector, calculating a second vector distance between the combination vector and the mathematical vector of the selected patent raw data, and when the calculated second vector distance does not exceed the threshold value, generating an evaluation pass message based on the recombined phrases.

In order to achieve the objective, the present invention discloses an innovative recombination recommendation method for corporate knowledge base, and the innovative recombination recommendation method includes steps of: linking a corporate knowledge base to a server-end device through network, wherein the corporate knowledge base stores pieces of patent raw data, each of the pieces of patent raw data corresponds to at least one mathematical vector, the server-end device comprises a non-transitory computer-readable storage medium storing computer readable instructions, and a hardware processor executing the computer readable instructions; receiving an innovation summary, splitting the innovation summary into phrases, and vectorizing each of the phrases to generate a phrase vector, by the server-end device; transmitting the phrase vectors to the corporate knowledge base, comparing the phrase vectors with one of the mathematical vectors one by one, and calculating a first vector distance between the phrase vectors and one of the mathematical vectors, by the server-end device; selecting the mathematical vector with the first vector distance exceeding a threshold value, and the patent raw data corresponding to the selected mathematical vector, by the server-end device; recombining the phrases, vectorizing the recombined phrases to generate a combination vector, calculating a second vector distance between the combination vector and the mathematical vector of the selected patent raw data, and when the calculated second vector distance does not exceed the threshold value, generating an evaluation pass message based on the recombined phrase, by the server-end device.

According to the above-mentioned system and method of the present invention, the difference between the present invention and the conventional technology is that, in the present invention, the innovation summary is received and split into the phrases, each of the phrases is vectorized to generate the phrase vector, the phrase vectors are transmitted to the corporate knowledge base and compared with the mathematical vectors of the pieces of patent raw data to calculate the first vector distance, and the piece of patent raw data with the first vector distance exceeding the threshold value is selected; the phrases are recombined and the recombined phrases are vectorized to generate a combination vector, the combination vector is compare with the mathematical vector of the selected patent raw data to calculate a second vector distance, and when the second vector distance does not exceed the threshold value, the evaluation pass message is generated based on the recombined phrase.

Therefore, the above-mentioned solution of the present invention is able to achieve the effect of improving the efficiency of innovative ideation.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of an innovative recombination recommendation system for corporate knowledge base, according to the present invention.

FIG. 2 is a flowchart of an innovative recombination recommendation method for corporate knowledge base, according to the present invention.

FIG. 3 is a schematic view showing an operation for innovation recombination, according to an application of the present invention.

FIG. 4 is a schematic view showing an operation of evaluating an innovation recombination, according to an application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first,’ ‘second,’ ‘third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

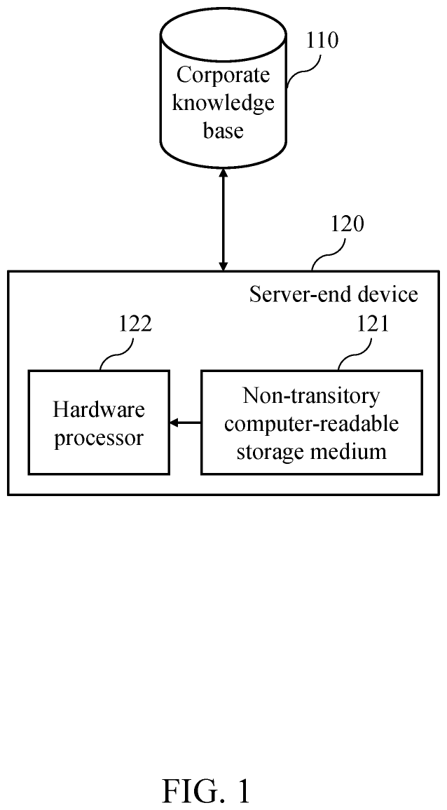

Please refer to FIG. 1. FIG. 1 is a system block diagram of an innovative recombination recommendation system for corporate knowledge base, according to the present invention. The system includes a corporate knowledge base 110 and a server-end device 120. The corporate knowledge base 110 is configured to store pieces of patent raw data, each of the pieces of patent raw data corresponds to a mathematical vector. In actual implementation, the corporate knowledge base 110 can include an internal corporate database, an external patent database. In addition, the mathematical vector means a value generated by vectorizing one piece of the patent raw data, and the vectorization method can be one-Hot Encoding, Bag of Words, TF-IDF, Word2Vec, GloVe, BERT, or the like.

The server-end device 120 is linked to the corporate knowledge base 110 through network, and the server-end device 120 includes a non-transitory computer-readable storage medium 121 and a hardware processor 122. In actual implementation, the non-transitory computer-readable storage medium 121 may include a hard disk, an optical disk, a flash memory, or the like. In addition, the computer readable instructions are executed by the server-end device 120. The computer readable instructions can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C#, Perl, Ruby, or PHP; the programming language can include regular procedural programming languages, such as C language or similar programming languages.

The hardware processor 122 is electrically connected to the non-transitory computer-readable storage medium 121, and configured to execute the computer readable instructions, to make the server-end device 120 execute the operations of: receiving an innovation summary, splitting the innovation summary into phrases, and vectorizing the phrases to generate phrase vectors; transmitting the phrase vectors to the corporate knowledge base and comparing the phrase vectors with the mathematical vectors, and calculates a first vector distance between the phrase vectors and one of the mathematical vector; when the first vector distance exceeds a threshold value, selecting the patent raw data corresponding to the one of the mathematical vector; recombining the phrases and vectorizing the recombined phrases to generate a combination vector, and calculating a second vector distance between the combination vector and the mathematical vector of the selected patent raw data, when the calculated second vector distance does not exceed the threshold value, generating an evaluation pass message based on the recombined phrase. In actual implementation, the server-end device 120 performs labelling by at least one of an automatic manner and a manual manner, splits the innovation summary into feature phrases, execute one of a clustering algorithm and an association rule algorithm to analyze the feature phrases, and generate a recombined technology combination based on the analysis result. In addition, the server-end device 120 vectors the recombined technology combination to generate a recombination vector, calculates a third vector distance between the recombination vector and the mathematical vectors, loads the patent raw data with the third vector distance exceeding the threshold value from the corporate knowledge base 110, as the prior art reference. In an embodiment, the server-end device 120 can further perform an association analysis based on the loaded patent raw data, and the association analysis can include an analysis for at least one of the recombined technology combination, a patent citation, joint inventors, and joint applicants. Therefore, the above-mentioned solution of the present invention is able to greatly simplify verification process to save time for verification.

It is to be particularly noted that, in actual implementation, the above-mentioned solution of the present invention can be implemented fully or partly based on hardware, for example, one or more component of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus. Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc, or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus.

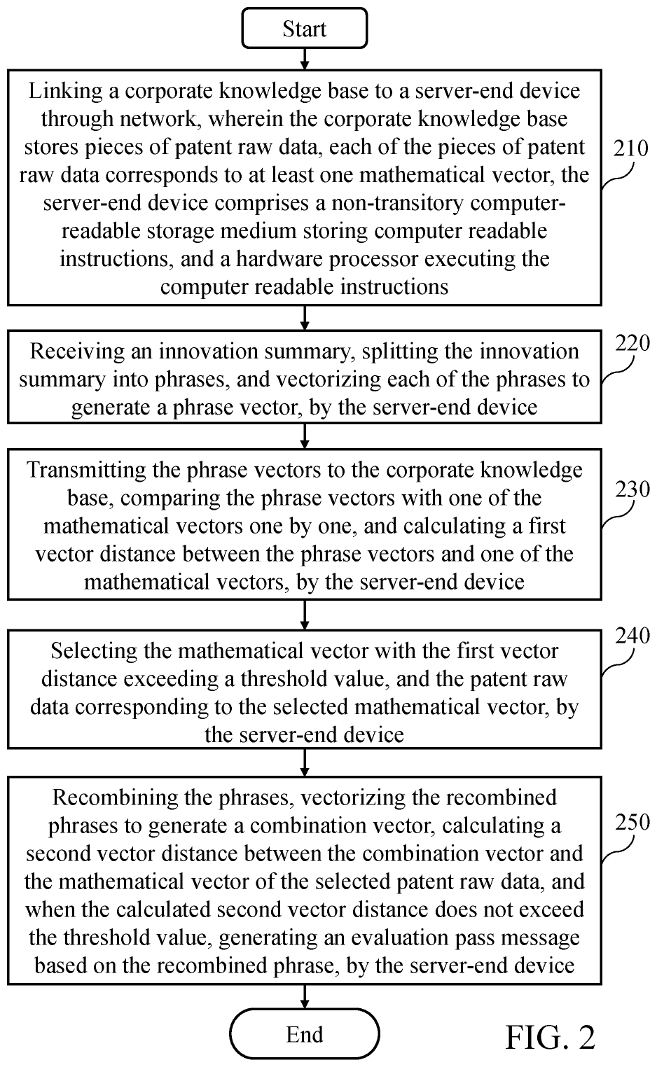

Please refer to FIG. 2. FIG. 2 is a flowchart of an innovative recombination recommendation method for corporate knowledge base, according to the present invention. As shown in FIG. 2, the innovative recombination recommendation method includes the following steps. In a step 210, a corporate knowledge base is linked to a server-end device through network, wherein the corporate knowledge base stores pieces of patent raw data, each of the pieces of patent raw data corresponds to at least one mathematical vector, the server-end device includes a non-transitory computer-readable storage medium storing computer readable instructions, and a hardware processor executing the computer readable instructions. In a step 220, the server-end device receives an innovation summary, splits the innovation summary into phrases, and vectorizes each of the phrases to generate a phrase vector. In a step 230, the server-end device transmits the phrase vectors to the corporate knowledge base, compares the phrase vectors with one of the mathematical vectors one by one, and calculates a first vector distance between the phrase vectors and one of the mathematical vectors. In a step 240, the server-end device selects the mathematical vector with the first vector distance exceeding a threshold value, and the patent raw data corresponding to the selected mathematical vector. In a step 250, the server-end device recombines the phrases, vectors the recombined phrases to generate a combination vector, calculates a second vector distance between the combination vector and the mathematical vector of the selected patent raw data, and when the calculated second vector distance does not exceed the threshold value, the server-end device generates an evaluation pass message based on the recombined phrase. Through the above-mentioned steps, the innovation summary can be received and split into the phrases, each of the phrases is vectorized to generate the phrase vector, the phrase vectors can be transmitted to the corporate knowledge base and compared with the mathematical vectors of the pieces of patent raw data to calculate the first vector distance, and one of the pieces of patent raw data with the first vector distance exceeding the threshold value is selected; the phrases are recombined and the recombined phrases are vectorized to generate the combination vector, the combination vector is compare with the mathematical vector of the selected patent raw data to calculate the second vector distance, and when the second vector distance does not exceed the threshold value, the evaluation pass message is generated based on the recombined phrase.

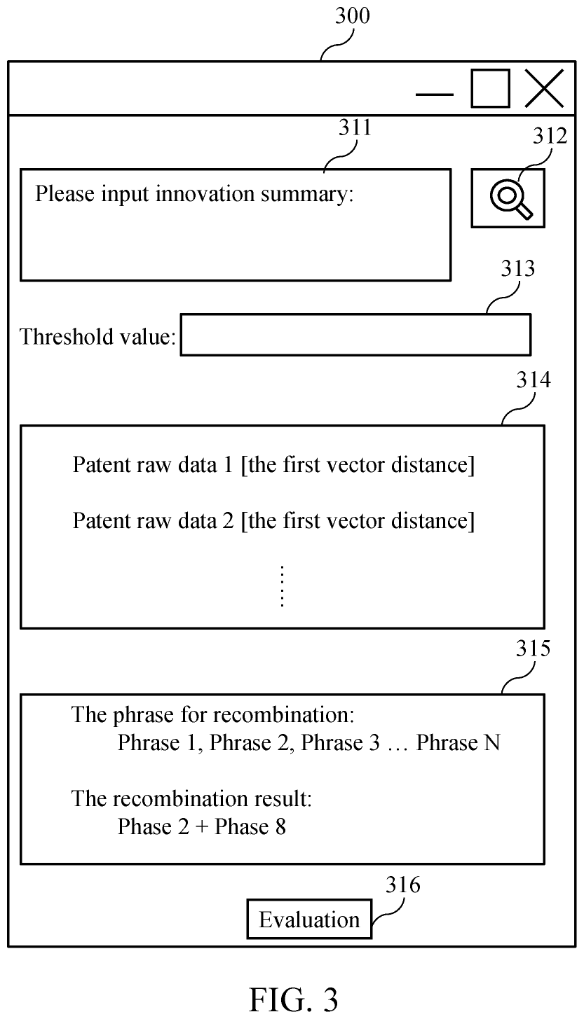

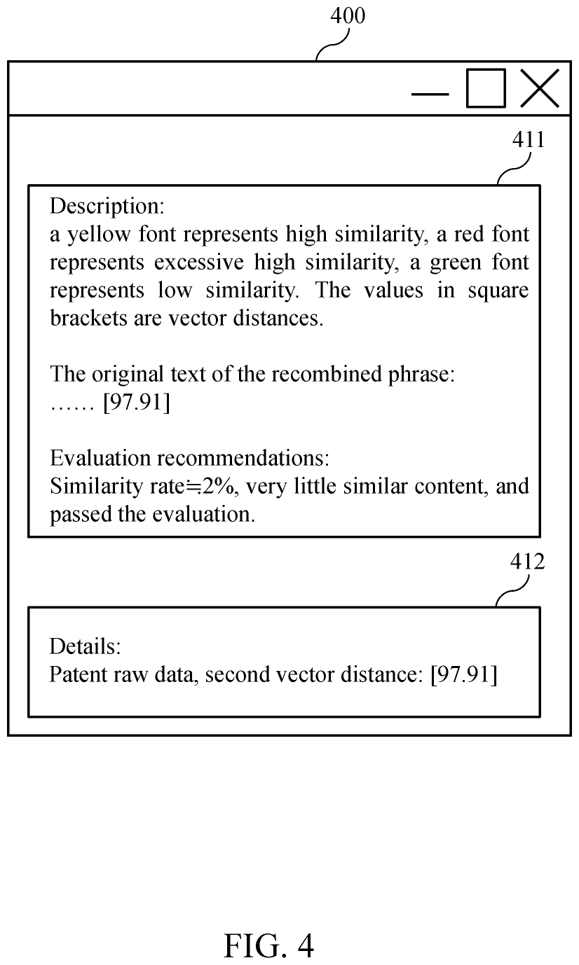

The embodiment of the present invention will be illustrated with reference to FIG. 3 and FIG. 4. FIG. 3 is a schematic view showing an operation for innovation recombination, according to an application of the present invention. As shown in FIG. 3, the user can freely create an innovative idea first, and input a description about the innovative idea in an input block 311 of an operation window 300 as an innovation summary, and input a threshold value in an input block 313 (such as a value of 90). Next, the user can click a search button 312 to make the server-end device 120 receive the innovation summary and split the innovation summary into phrases, and vectorize the phrases to generate phrase vectors. The server-end device 120 transmits the phrase vectors to the corporate knowledge base 110 to be compared with mathematical vectors of pieces of the patent raw data, one by one, to calculate first vector distances between the phrase vectors and the mathematical vectors, and when one of the first vector distances exceeds a threshold value, the server-end device 120 selects the patent raw data corresponding to the one of the first vector distances and displays the selected patent raw data and the first vector distance corresponding thereto in a display block 314 together. In addition, the split phrase can be displayed in an operation block 315 for providing the user to recombine phrases through a cursor click or drag-and-drop operation. For example, when the innovation summary is split into a phrase 1 to a phrase N, the user can click the phrase 2 and the phrase 8 for recombination, user then can click an evaluation button 316 to evaluate whether the corporate knowledge base 110 has a piece of patent raw data with high similarity to the recombined phrases. In this way, the user can obtain the patent raw data related to the innovation summary, and select some phrases for recombination based on the first vector distance. For example, the user can select the phrase with higher first vector distance (it represents a lower similarity) for phrase recombination.

FIG. 4 is a schematic view showing an operation of evaluating an innovation recombination, according to an application of the present invention. As shown in FIG. 4, the above-mentioned embodiment is continuously taken as an example. When the user clicks the evaluation button 316 to evaluate whether the corporate knowledge base 110 has a piece of patent raw data with high similarity to the recombined phrase. The server-end device 120 vectorizes the recombined phrase to generate a combination vector, and calculates a second vector distance between the combination vector and the mathematical vector of the selected patent raw data, when the calculated second vector distance does not exceed the threshold value, the server-end device 120 generates an evaluation pass message based on the recombined phrase, and displays the evaluation pass message in the display block 411 of the evaluation window 400. In addition, other details can be displayed in the display block 412, for example, the patent raw data and the second vector distance can be displayed for providing the user to determine the similarity between the recombined phrase and the selected patent raw data. The long distance represents low similarity, and short distance represents higher similarity. In addition, in actual implementation, different font colors can be used to present similarity, for example, a yellow font represents high similarity, a red font represents excessive high similarity, a green font represents low similarity.

According to above-mentioned contents, the difference between the present invention and the conventional technology is that, in the present invention, the innovation summary is received and split into the phrases, each of the phrases is vectorized to generate the phrase vector, the phrase vectors are transmitted to the corporate knowledge base and compared with the mathematical vectors of the pieces of patent raw data to calculate the first vector distance, and the piece of patent raw data with the first vector distance exceeding the threshold value is selected; the phrases are recombined and the recombined phrases are vectorized to generate the combination vector, the combination vector is compare with the mathematical vector of the selected patent raw data to calculate the second vector distance, and when the second vector distance does not exceed the threshold value, the evaluation pass message is generated based on the recombined phrase. Therefore, the above-mentioned solution of the present invention is able to solve the convention problem, so as to achieve the effect of improving the efficiency of innovative ideation.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An innovative recombination recommendation system for a corporate knowledge base, comprising:
a corporate knowledge base, configured to store pieces of patent raw data, wherein each of the pieces of patent raw data corresponds to at least one mathematical vector; and
a server-end device, linked to the corporate knowledge base through network, wherein the server-end device comprises:
a non-transitory computer-readable storage medium, configured to store computer readable instructions; and
a hardware processor, electrically connected to the non-transitory computer-readable storage medium, and configured to execute computer readable instructions to make the server-end device execute:
receiving an innovation summary, splitting the innovation summary into phrases, and vectorizing each of the phrases to generate a phrase vector;
transmitting the phrase vectors to the corporate knowledge base, and comparing the phrase vectors with the mathematical vectors, one by one, and calculating a plurality of first vector distances between the phrase vectors and each of the mathematical vectors;
when one of the first vector distances exceeds a threshold value, selecting a piece of the patent raw data corresponding to the one of the first vector distances; and
recombining the phrases, vectorizing the recombined phrases to generate a combination vector, calculating a second vector distance between the combination vector and the mathematical vector of the selected piece of patent raw data, and when the calculated second vector distance does not exceed the threshold value, generating an evaluation pass message based on the recombined phrases.

2. The innovative recombination recommendation system for a corporate knowledge base according to claim 1, wherein the server-end device performs labelling by at least one of an automatic manner and a manual manner, and splits the innovation summary into one or more feature phrases.

3. The innovative recombination recommendation system for a corporate knowledge base according to claim 2, wherein the server-end device executes one of a clustering algorithm and an association rule algorithm to analyze the feature phrases, and generates at least one recombined technology combination based on an analysis result.

4. The innovative recombination recommendation system for a corporate knowledge base according to claim 3, wherein the server-end device vectors the at least one recombined technology combination to generate a recombination vector, calculates a third vector distance between the recombination vector and one of the mathematical vectors, and loads the patent raw data with the third vector distance exceeding the threshold value from the corporate knowledge base, as a prior art reference.

5. The innovative recombination recommendation system for a corporate knowledge base according to claim 4, wherein the server-end device performs an association analysis based on the loaded patent raw data, and the association analysis comprises an analysis for at least one of the recombined technology combination, a patent citation, joint inventors, and joint applicants.

6. An innovative recombination recommendation method for a corporate knowledge base, comprising:
linking the corporate knowledge base to a server-end device through network, wherein the corporate knowledge base stores pieces of patent raw data, wherein each of the pieces of patent raw data corresponds to at least one mathematical vector, wherein the server-end device comprises a non-transitory computer-readable storage medium storing computer readable instructions, and a hardware processor executing the computer readable instructions to make the server-end device execute:
receiving an innovation summary, splitting the innovation summary into phrases, and vectorizing each of the phrases to generate a phrase vector, by the server-end device;
transmitting the phrase vectors to the corporate knowledge base, comparing the phrase vectors with one of the mathematical vectors one by one, and calculating a first vector distance between the phrase vectors and one of the mathematical vectors, by the server-end device;
selecting a mathematical vector from the mathematical vectors with the first vector distance exceeding a threshold value, and the patent raw data corresponding to the selected mathematical vector, by the server-end device; and
recombining the phrases, vectorizing the recombined phrases to generate a combination vector, calculating a second vector distance between the combination vector and the mathematical vector of the selected patent raw data, and when the calculated second vector distance does not exceed the threshold value, generating an evaluation pass message based on the recombined phrase, by the server-end device.

7. The innovative recombination recommendation method for a corporate knowledge base according to claim 6, wherein the server-end device performs labelling by at least one of an automatic manner and a manual manner, and splits the innovation summary into one or more feature phrases.

8. The innovative recombination recommendation method for a corporate knowledge base according to claim 7, wherein the server-end device executes one of a clustering algorithm and an association rule algorithm to analyze the feature phrases, and generates at least one recombined technology combination based on an analysis result.

9. The innovative recombination recommendation method for a corporate knowledge base according to claim 8, wherein the server-end device vectors the recombined technology combination to generate a recombination vector, calculates a third vector distance between the recombination vector and one of the mathematical vectors, and loads the patent raw data with the third vector distance exceeding the threshold value from the corporate knowledge base, as a prior art reference.

10. The innovative recombination recommendation method for a corporate knowledge base according to claim 9, wherein the server-end device performs an association analysis based on the loaded patent raw data, and the association analysis comprises an analysis for at least one of the recombined technology combination, a patent citation, joint inventors, and joint applicants.
